(19) United States
(12) Patent Application Publication
(10) Pub. No.: US 2020/0189525 A1
(43) Pub. Date: Jun. 18, 2020

(54) ACTIVE VEHICLE CONTROL NOTIFICATION METHOD AND SYSTEM

(71) Applicants: Hyundai Motor Company, Seoul (KR); Kia Motors Corporation, Seoul (KR)

(72) Inventors: Yeon Ji KIM, Seoul (KR); Kyo Woong CHOO, Seoul (KR); Jeong Hun KIM, Seongnam-si (KR); Ah Rang LEE, Seoul (KR)

(73) Assignees: Hyundai Motor Company, Seoul (KR); Kia Motors Corporation, Seoul (KR)

(21) Appl. No.: 16/415,169

(22) Filed: May 17, 2019

(30) Foreign Application Priority Data
Dec. 12, 2018 (KR) 10-2018-0159782

(51) Int. Cl. B60S 1/08; G07C 5/00

(52) U.S. Cl. CPC B60S 1/0818; G07C 5/008

(57) ABSTRACT

An active vehicle control notification method may include receiving external data from a server by a vehicle, determining whether the external data received from the server and a control driving condition of the vehicle are matched, by the vehicle, when the external data and the control driving condition are not matched, correcting the external data based on the control driving condition inside the vehicle, and uploading the corrected external data to the server.

The present application claims priority to Korean Patent Application No. 10-2018-0159782, filed on Dec. 12, 2018, the entire contents of which is incorporated herein for all purposes by this reference.

### BACKGROUND OF THE INVENTION

### Field of the Invention

The present invention relates to an active vehicle control notification method and system.

### Description of Related Art

In general, a vehicular information provision device displays a current position of a vehicle on a display and provides various external information items required for driving, and for example, displays a heading direction of the vehicle, a distance to a target destination, a current moving speed of a vehicle, a path which is set by a driver prior to driving, and an optimum path to the destination.

Conventional technology has a problem in that only received information is output from a server even if data received from the external server is input as different information from an actual situation, and inaccurate information is provided to a driver.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an active vehicle control notification method and system.

In more detail, various aspects of the present invention are directed to providing an active vehicle control notification method for determining whether external data revived from the outside of a vehicle and a control driving condition of the vehicle are matched, correcting external data based on the control driving condition within the vehicle when the external data and the control driving condition are not matched, and uploading the corrected external data to a server.

Additional advantages, objects, and features of the present invention will be set forth in part in the description which follows and in part will become apparent to those having ordinary skill in the art upon examination of the following or may be learned from practice of the present invention. The objectives and other advantages of the present invention may be realized and attained by the structure particularly pointed out in the written description and claims hereof as well as the appended drawings.

To achieve these objects and other advantages and in accordance for an exemplary embodiment of the present invention, as embodied and broadly described herein, an active vehicle control notification method may include receiving external data from a server by a vehicle, determining whether the external data received from the server and a control driving condition of the vehicle are matched, by the vehicle, when the external data and the control driving condition are not matched, correcting the external data based on the control driving condition inside the vehicle, and uploading the corrected external data to the server.

In various exemplary embodiments of the present invention, the external data may include weather data, traffic information data, and electric vehicle charging station data.

In various exemplary embodiments of the present invention, the determining of whether the external data received from the server and a control driving condition of the vehicle are matched, by the vehicle may include, when the vehicle receives the weather data including a precipitation state as the external data, determining whether a vehicle driving time is equal to or greater than a first driving time, determining whether a wiper of the vehicle is operated for a first operation time or greater, determining whether the wiper is operated normally for a first period, and when the wiper is operated normally for the first period, concluding that current weather is not in a precipitation state.

In various exemplary embodiments of the present invention, the determining of whether the external data received from the server and a control driving condition of the vehicle are matched, by the vehicle may include, when the vehicle receives the weather data including a fine state as the external data, determining whether a wiper of the vehicle is operated for a second operation time or greater, determining whether the wiper is operated normally for a second period, and when the wiper is operated normally for the second period, concluding that current weather is not in a fine state.

In various exemplary embodiments of the present invention, the determining of whether the external data received from the server and a control driving condition of the vehicle are matched, by the vehicle may include when the vehicle receives traffic information data as the external data and the traffic condition is in a smooth state, determining whether the vehicle drives on an expressway, when the vehicle drives on the expressway, determining whether the vehicle drives at a first driving speed or less for a first driving time or greater, and when the vehicle is operated at the first driving speed or less for the first driving time or greater, concluding that a traffic condition of the expressway is in a congested state.

In various exemplary embodiments of the present invention, the active vehicle control notification method may further include, when the vehicle does not drive on the expressway, determining that the vehicle drives on a general road, determining whether the vehicle drives at a second driving speed or less for the first driving time or greater, and when the vehicle drives at a second driving speed or less for the first driving time or greater, determining that the traffic condition of the general road is in a congested state.

In various exemplary embodiments of the present invention, the determining of whether the external data received from the server and a control driving condition of the vehicle are matched, by the vehicle may include, when the vehicle receives data indicating that an extra charger is present in an electric vehicle charging station as the external data, determining whether the extra charger is present in the electric vehicle charging station, determining whether all the extra chargers are used, and when all the extra chargers are used, concluding that the extra charger is not present.

In various exemplary embodiments of the present invention, the active vehicle control notification method may further include transmitting and receiving the corrected external data to or from another vehicle through wireless communication, by the vehicle.

In various exemplary embodiments of the present invention, the active vehicle control notification method may further include outputting a message corresponding to the corrected external data by the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram showing a configuration of an active vehicle control notification system according to an exemplary embodiment of the present invention;

FIG. 2 and FIG. 3 are flowcharts showing a weather notification method according to an exemplary embodiment of the present invention;

FIG. 4 is a flowchart showing a traffic condition notification method according to an exemplary embodiment of the present invention;

FIG. 5 is a flowchart showing an electric vehicle charging station notification method according to an exemplary embodiment of the present invention; and

FIG. 6 and FIG. 7 are diagrams showing a situation in which corrected external data is displayed according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Reference will now be made in detail to apparatuses and various methods according to the exemplary embodiments of the present invention, examples of which are illustrated in the accompanying drawings. The suffixes “module” and “unit” of elements herein are used for convenience of description and thus may be used interchangeably and do not have any distinguishable meanings or functions.

In the description of exemplary embodiments of the present invention, it will be understood that, when an element is referred to as being “on” or “under” or “before” or “after” another element, the element may be directly adjacent to the other element, or intervening elements may also be present.

It will be understood that, although the terms “first”, “second”, “A”, “B”, “(a)”, “(b)”, etc. may be used herein to describe various elements of the present invention, these terms are only used to distinguish one element from another element, and the essential order or sequence of the corresponding elements is not limited by these terms. It will be understood that when one element is referred to as being “connected to”, “coupled to”, or “accessing” another element, the one element may be “connected to”, “coupled to”, or “access” another element via a further element, or the one element may be directly connected to or directly access the other element.

The terms “comprises”, “includes”, and “has” when used herein should be interpreted not to exclude other elements but to further include such other elements since the corresponding elements may be included unless mentioned otherwise. All terms including technical or scientific terms have the same meanings as generally understood by a person having ordinary skill in the art to which the present invention pertains unless mentioned otherwise. Generally used terms, such as terms defined in a dictionary, should be interpreted to coincide with meanings in the related art from the context. Unless differently defined in an exemplary embodiment of the present invention, such terms should not be interpreted in an ideal or excessively formal manner.

Various aspects of the present invention are directed to providing an active vehicle control notification method and system for receiving external data from a server by a vehicle, determining whether the external data and a control driving condition of the vehicle are matched, correcting the external data, uploading the corrected external data to a server, and making a request to the server for correction of the external data.

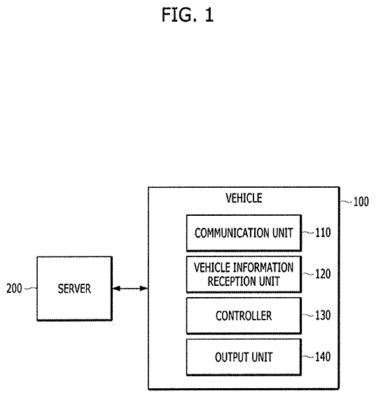

FIG. 1 is a block diagram showing a configuration of an active vehicle control notification system according to an exemplary embodiment of the present invention.

Referring to FIG. 1, the active vehicle control notification system according to an exemplary embodiment of the present invention may include a vehicle 100 and a server 200, and the vehicle 100 may include a communication unit 110, a vehicle information reception unit 120, a controller 130, and an output unit 140.

The communication unit 110 may transmit and receive data to or from the server 200 via communication therewith. The communication unit 110 may receive external data from the server 200. The external data may include weather data, road traffic condition data, electric vehicle charging station data, and the like.

In the instant case, the road traffic condition data may provide a driving path service to a destination from a starting point and may provide traffic information which is generated in real time during provision of the driving path service or traffic information which is generated for a preset time period.

When the controller 130 corrects the external data, the communication unit 110 may upload to the corrected external data to the server 200. Furthermore, when the controller 130 corrects the external data, the communication unit 110 may transmit and receive with a surrounding vehicle via wireless communication.

The vehicle information reception unit 120 may receive driving control information from each system and each controller in a vehicle.

For example, the vehicle information reception unit 120 may include information on a wiper, a window, a sunroof, a speedometer, a global positioning system (GPS) (which is divided according to a current position and a road type), internal temperature information related to a vehicle, a vehicle driving state, and the like.

The controller 130 may receive the external data from the server 200 and may determine whether the external data and a control driving condition of the vehicle are matched to check an error of the external data.

The controller 130 may correct the external data based on the control driving condition during a current vehicle operation when the error is present in the external data. As such, the corrected external data may be uploaded to the server 200. Therethrough, the controller 130 may make a request to the server 200 for correction of an error of the external data.

The controller 130 may check whether an error is present in weather data based on external information and vehicular operation information.

The controller 130 may check whether the error is present in the weather data according to a wiper is operated.

For example, even if the weather data provides information indicating that it rains, the controller 130 may determine that it does not rain when the vehicle 100 drives at a preset speed or greater and a wiper is not operated for a preset time or greater.

For example, even if the weather data provides information indicating that it does not rain, the controller 130 may determine that it rains when a vehicle viper is operated for a preset time or greater.

For example, even if the weather data provides information indicating that a temperature is 10 to 5 below zero and it snows, the controller 130 may determine that it does not snow when a vehicular heating system is turned off, a vehicle drives for a preset driving time or greater, and a wiper is turned off within a preset time.

The controller 130 may determine whether an error is present in the external data based on whether a window and/or a sunroof are open or closed.

When the window and/or the sunroof are open for a preset time or greater, the controller 130 may determine that an ultrafine dust level is low. Accordingly, the controller 130 may make a request for a change in vehicular air conditioning to outdoor temperature from indoor temperature.

The controller 130 may check whether an error is present based on the vehicular operation information.

The controller 130 may determine whether an error is present based on a road type, a vehicle driving time, and a duration time of driving time of the vehicle 100.

For example, when a driving road type is a general road, reception information indicates a ‘smooth’ section, and a vehicle drives at 30 km/h or less for 10 minutes or more, the controller 130 may determine a current section to be a ‘congested’ section. As such, the controller 130 may make a request to the server 200 for correction of the external data to a ‘congested’ section.

For example, the controller 130 may determine a current section to be a ‘congested’ section when a driving road type is an expressway, reception information indicates a ‘smooth’ section, and a vehicle drives at 60 km/h or less for 10 minutes or more. As such, the controller 130 may make a request to the server 200 for correction of the external data to a ‘congested’ section.

The controller 130 may check whether an error is present in electric vehicle charging station data based on the vehicular operation information.

For example, upon receiving data indicating that an extra charger is present in an electric vehicle charging station, the controller 130 may determine whether an extra charger is present in the electric vehicle charging station, may determine that all chargers are used when an extra charger is not present, and may make a request to the server 200 for correction of the received external data.

Upon receiving the corrected external data including a push message from the outside, the controller 130 may perform control to output a push message to the output unit 140.

The output unit 140 may output the external data received from the server 200 to a screen.

Upon receiving the corrected external data from the server 200, the output unit 140 may output information indicating whether the corrected external data is applied, as the push message.

The output unit 140 may be configured for exchanging traffic information data with an accompanied vehicle through the external data. In the instant case, the output unit 140 may receive a car-to-car message from the accompanied vehicle.

The server 200 may transmit and receive the external data to or from the vehicle. The server 200 may correct the external data in a response to regular external data. For example, the server 200 may receive a car-to-server message from the vehicle and may correct the external data.

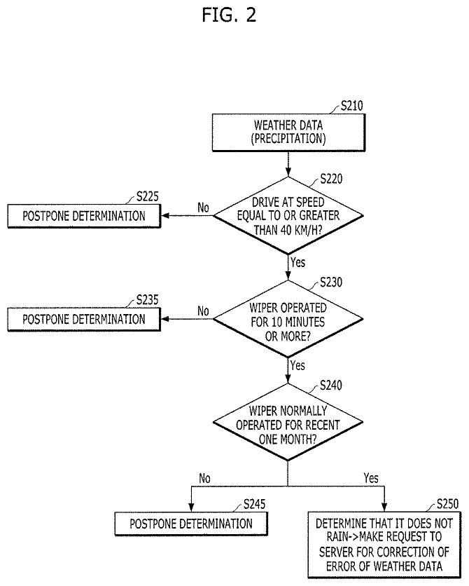

FIG. 2 is a flowchart showing a weather notification method according to an exemplary embodiment of the present invention.

Referring to FIG. 2, when the vehicle 100 receives external data, the external data may include weather data. The controller 130 may receive data indicating that a rainfall probability is 70% as the weather data (S210).

After operation S210, the controller 130 may determine whether a vehicle drives at a speed equal to or greater than 40 Km/h (S220). When operation S220 is not satisfied, the controller 130 may postpone determination of whether an error is present in the received external data (S225).

When operation S220 is satisfied, the controller 130 may determine whether a wiper is operated for 10 minutes or greater (S230). When operation S230 is not satisfied, the controller 130 may postpone determination of whether an error is present in the received external data (S235).

When operation S230 is satisfied, the controller 130 may determine whether the wiper has been operated normally for recent one month (S240). When operation S240 is not satisfied, the controller 130 may postpone determination of whether an error is present in the received external data (S245).

When operation S240 is satisfied, the controller 130 may determine that it does not rain. As such, the controller 130 may make a request to the server 200 for correction of an error of the weather data (S250).

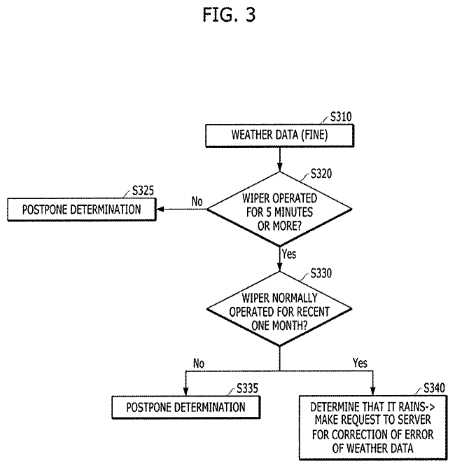

FIG. 3 is a flowchart showing a weather notification method according to an exemplary embodiment of the present invention.

Referring to FIG. 3, when the vehicle 100 receives external data, the external data may include weather data. The controller 130 may receive data indicating that it is fine (S310).

When operation S310 is satisfied, the controller 130 may determine whether a wiper is operated for 5 minutes or greater (S320). When operation S320 is not satisfied, the controller 130 may postpone determination of whether an error is present in the received external data (S325).

When operation S320 is satisfied, the controller 130 may determine whether the wiper has been operated normally for recent 1 month (S330). When operation S330 is not satisfied, the controller 130 may postpone determination of whether an error is present in the received external data (S335).

When operation S330 is satisfied, the controller 130 may determine that it rains. As such, the controller 130 may make a request to the server 200 for correction of an error of the weather data (S340).

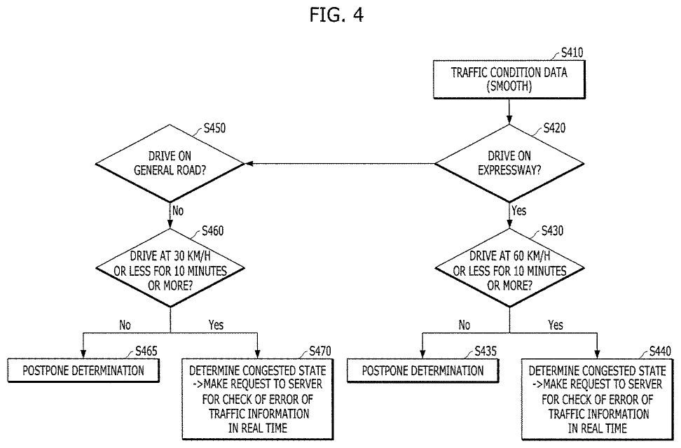

FIG. 4 is a flowchart showing a traffic condition notification method according to an exemplary embodiment of the present invention.

Referring to FIG. 4, when the vehicle 100 receives external data, the external data may include traffic data. The controller 130 may receive data indicating that a traffic condition is smooth (S410).

When operation S410 is satisfied, the controller 130 may determine that the vehicle drives on an expressway (S420).

When operation S420 is satisfied, the controller 130 may determine whether the vehicle 100 drives at 60 km/h or less for 10 minutes or greater (S430). When operation S430 is not satisfied, the controller 130 may postpone determination of whether an error is present in the received external data (S435).

When operation S430 is satisfied, the controller 130 may determine that a traffic condition of the expressway is a congested state. As such, the controller 130 may make a request to the server 200 for correction of an error of the traffic condition data (S440).

When operation S440 is not satisfied, the controller 130 may determine that the vehicle 100 drives on a general road (S450).

When operation S450 is satisfied, the controller 130 may determine whether the vehicle 100 drives at 30 km/h or less for 10 minutes or greater (S460). When operation S460 is not satisfied, the controller 130 may postpone determination of whether an error is present in the received external data (S465).

When operation S460 is satisfied, the controller 130 may determine that a traffic condition of a general road is a congested state. As such, the controller 130 may make a request to the server 200 for correction of an error of the traffic condition data (S470).

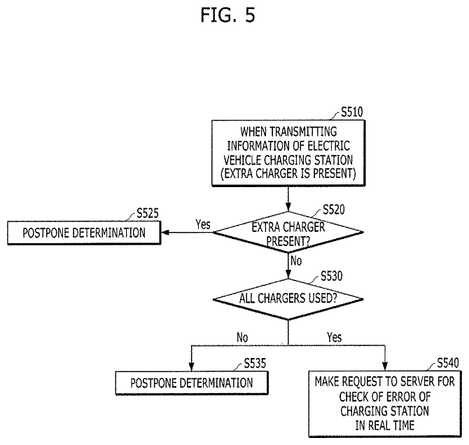

FIG. 5 is a flowchart showing an electric vehicle charging station notification method according to an exemplary embodiment of the present invention.

Referring to FIG. 5, when the vehicle 100 receives external data, the external data may include electric vehicle charging station data. The controller 130 may receive data indicating that an extra charger is present in an electric vehicle charging station (S510).

After operation S510, the controller 130 may determine whether an extra charger is present in the electric vehicle charging station (S520). When operation S520 is not satisfied, the controller 130 may postpone determination of whether an error is present in the received external data (S525).

When operation S520 is not satisfied, the controller 130 may determine that all chargers of the electric vehicle charging station are used (S530). When operation S530 is not satisfied, the controller 130 may postpone determination of whether an error is present in the received external data (S535).

When operation S530 is satisfied, the controller 130 may then make a request to the server 200 for correction of an error charging station data (S540).

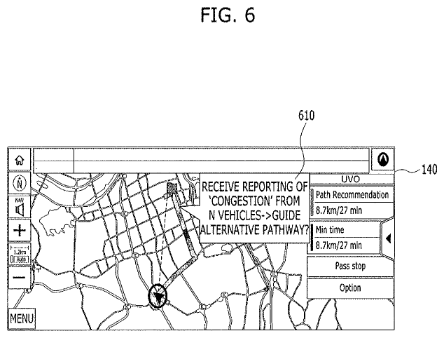

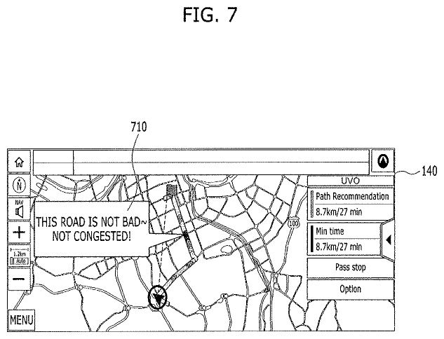

FIG. 6 and FIG. 7 are diagrams showing a situation in which corrected external data is displayed according to an exemplary embodiment of the present invention.

Referring to FIG. 6, external data received by the vehicle 100 from the server 200 may be traffic condition information.

After receiving the external data from the server 200 and outputting the external data, the vehicle 100 may receive the corrected external data from the server 200. The vehicle 100 may display the corrected external data as push data 610. The vehicle 100 may apply the push data 610 to the output unit 140 in a response to the corrected external data. Therewith, the output unit 140 may output a message corresponding to the received push data 610.

Referring to FIG. 7, the vehicle 100 may be connected to the accompanied vehicle via wireless communication to transmit and receive data. After receiving external data from the server 200 and outputting the data, the vehicle 100 may receive the external data from the accompanied vehicle. In the instant case, the vehicle 100 may exchange traffic information data included in the external data. The vehicle 100 that receives the external data from the accompanied vehicle may display traffic information through the output unit 140. Therewith, the output unit 140 may output a message corresponding to push data 710 received from the accompanied vehicle.

An active vehicle control notification method and system according to an exemplary embodiment of the present invention may have the following advantages.

First, more accurate information may be advantageously provided by providing information which is corrected based on a vehicle control condition.

Second, a predetermined function may be advantageously embodied without an increase in material costs by use of a conventional system.

Third, a driver may advantageously and intuitively check by providing accurate external data to a customer.

It will be appreciated by persons skilled in the art that the effects that could be achieved with the present invention are not limited to what has been particularly described hereinabove and other advantages of the present invention will be more clearly understood from the detailed description.

The aforementioned method according to an exemplary embodiment of the present invention may also be embodied as computer readable code on a computer readable recording medium. Examples of the computer readable recording medium include read-only memory (ROM), random-access memory (RAM), CD-ROMs, magnetic tapes, floppy disks, optical data storage devices, etc. The computer readable recording medium may also be distributed over network coupled computer systems so that the computer readable code is stored and executed in a distributed fashion. Also, functional programs, code, and code segments for accomplishing the aforementioned method may be easily construed by programmers skilled in the art to which the present invention pertains.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An active vehicle control notification method comprising:
receiving external data from a server by a vehicle;
determining when the external data received from the server and a control driving condition of the vehicle are matched, by the vehicle;
when the external data and the control driving condition are not matched, correcting the external data based on the control driving condition inside the vehicle; and
uploading the corrected external data to the server.

2. The active vehicle control notification method of claim 1, wherein the external data includes weather data, traffic information data, and electric vehicle charging station data.

3. The active vehicle control notification method of claim 2, wherein the determining of when the external data received from the server and the control driving condition of the vehicle are matched, by the vehicle includes:
as the vehicle receives the weather data including a precipitation state as the external data, determining when a vehicle driving time is equal to or greater than a first driving time;
determining when a wiper of the vehicle is operated for a first operation time or greater;
determining when the wiper is operated normally for a first period; and
when the wiper is operated normally for the first period, concluding that current weather is not in the precipitation state.

4. The active vehicle control notification method of claim 2, wherein the determining of when the external data received from the server and the control driving condition of the vehicle are matched, by the vehicle includes:
as the vehicle receives the weather data including a fine state as the external data, determining when a wiper of the vehicle is operated for a second operation time or greater;
determining when the wiper is operated normally for a second period; and
when the wiper is operated normally for the second period, concluding that current weather is not in a fine state.

5. The active vehicle control notification method of claim 2, wherein the determining of when the external data received from the server and the control driving condition of the vehicle are matched, by the vehicle includes:
when the vehicle receives the traffic information data as the external data and the traffic condition is in a smooth state, determining when the vehicle drives on an expressway;
when the vehicle drives on the expressway, determining when the vehicle drives at a first driving speed or less for a first driving time or greater; and
when the vehicle is operated at the first driving speed or less for the first driving time or greater, concludes that a traffic condition of the expressway is in a congested state.

6. The active vehicle control notification method of claim 5, further including:
when the vehicle does not drive on the expressway, concluding that the vehicle drives on a general road;
determining when the vehicle drives at a second driving speed or less for the first driving time or greater; and
when the vehicle drives at the second driving speed or less for the first driving time or greater, concluding that a traffic condition of the general road is in a congested state.

7. The active vehicle control notification method of claim 2, wherein the determining of when the external data received from the server and the control driving condition of the vehicle are matched, by the vehicle includes:
when the vehicle receives data indicating that an extra charger is present in an electric vehicle charging station as the external data, determining when the extra charger is present in the electric vehicle charging station;
determining when all the extra chargers are used; and
when all the extra chargers are used, concluding that the extra charger is not present.

8. The active vehicle control notification method of claim 1, further including transmitting and receiving the corrected external data to or from another vehicle through wireless communication, by the vehicle.

9. The active vehicle control notification method of claim 8, further including outputting a message corresponding to the corrected external data by the vehicle.

10. A computer readable recording medium having recorded thereon a program for executing the active vehicle control notification method of claim 1.

11. An active vehicle control notification system comprising:
a communication unit configured to receive external data from a server;
a vehicle information reception unit configured to receive a control driving condition of a vehicle; and
a controller configured to determine when the external data and the control driving condition of the vehicle are matched and configured to correct the external data based on the control driving condition within the vehicle when the external data and the control driving condition are not matched,
wherein the communication unit uploads the corrected external data to the server.

12. The active vehicle control notification system of claim 11, wherein the external data includes weather data, traffic information data, and electric vehicle charging station data.

13. The active vehicle control notification system of claim 12, wherein, upon receiving the weather data including a precipitation state as the external data, the controller determines when a vehicle driving time is equal to or greater than a first driving time, determines when a wiper of the vehicle is operated for a first operation time or greater, determines when the wiper is operated normally for a first period, and concludes that current weather is not in the precipitation state when the wiper is operated normally for the first period.

14. The active vehicle control notification system of claim 12, wherein upon receiving the weather data including a fine state as the external data, the controller determines when a wiper of the vehicle is operated for a second operation time or greater, determines when the wiper is operated normally for a second period, and concludes that current weather is not in a fine state when the wiper is operated normally for the second period.

15. The active vehicle control notification system of claim 12, wherein the controller receives the traffic information data as the external data, determines when the vehicle drives on an expressway when the traffic condition is in a smooth state, determines when the vehicle drives at a first driving speed or less for a first driving time or greater when the vehicle drives on the expressway, and concludes that a traffic condition of the expressway is in a congested state when the vehicle is operated at the first driving speed or less for the first driving time or greater.

16. The active vehicle control notification system of claim 15, wherein the controller determines that the vehicle drives on a general road when the vehicle does not drive on the expressway, determines when the vehicle drives at a second driving speed or less for the first driving time or greater, and concludes that a traffic condition of the general road is in a congested state when the vehicle drives at a second driving speed or less for the first driving time or greater.

17. The active vehicle control notification system of claim 12, wherein, when the vehicle receives data indicating that an extra charger is present in an electric vehicle charging station as the external data, the controller determines when the extra charger is present in the electric vehicle charging station, determines when all the extra chargers are used, and concludes that the extra charger is not present when all the extra chargers are used.

18. The active vehicle control notification system of claim 11, wherein the communication unit transmits and receives the corrected external data to or from another vehicle through wireless communication.

19. The active vehicle control notification system of claim 18, wherein the output unit outputs a message corresponding to the corrected external data.
